(19) United States
(12) Patent Application Publication
(10) Pub. No.: US 2006/0064874 A1
(43) Pub. Date: Mar. 30, 2006

(54) Method of manufacturing a node and of securing a plurality of structural components to the node to form an article

(76) Inventors: Kenneth J. Bonnville, Peoria, AZ (US); Robert D. Durand, Lancaster, PA (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/241,737

(22) Filed: Sep. 30, 2005

Related U.S. Application Data
(60) Provisional application No. 60/614,693, filed on Sep. 30, 2004.

(51) Int. Cl. B23P 17/00; B21D 47/00

(52) U.S. Cl. 29/897; 29/412; 29/417; 29/897.2; 29/419.2

(57) ABSTRACT

A method of manufacturing a node and of securing a plurality of structural components to the node to form an article, such as a vehicle frame assembly, includes the initial step of extruding a workpiece having a plurality of longitudinally extending passageways formed therethrough. A plurality of interim workpieces can be formed by separating portions of the extruded workpiece into a plurality of discrete sections. If necessary, the interim workpieces can be machined to provide a plurality of nodes. The nodes can be formed or machined to have one or more bores formed therethrough that extend from a first outer surface to a second outer surface. A portion of the structural member is inserted into the bore from the first outer surface of the node, while a magnetic pulse forming/welding inductor is inserted into the bore from the second outer surface of the node. The magnetic pulse forming/welding inductor is then operated to secure the portion of the structural member to the node to form an assembly.

### CROSS-REFERENCE TO RELATED APPLICATIONS

This application claims the benefit of U.S. Provisional Application No. 60/614,693, filed Sep. 30, 2004, the disclosure of which is incorporated herein by reference.

### BACKGROUND OF THE INVENTION

This invention relates in general to methods of manufacturing articles that are composed of pluralities of structural components. In particular, this invention relates to an improved method of manufacturing a node and of securing a plurality of structural components to such a node to form an article.

Many land vehicles in common use, such as automobiles, vans, and trucks, include a frame assembly that is supported upon a plurality of ground-engaging wheels by a resilient suspension system. The structures of known frame assemblies can be divided into two general categories, namely, separate and unitized. In a typical separate frame assembly, the structural components of the frame portion of the vehicle are separate and independent from the structural components of the body portion of the vehicle. When assembled, the frame portion of the assembly is resiliently supported upon the vehicle wheels by the suspension system and serves as a platform upon which the body portion of the assembly and other components of the vehicle can be mounted. Separate frame assemblies of this general type are found in most older vehicles, but remain in common use today for many relatively large or specialized use modern vehicles, such as large vans, sport utility vehicles, and trucks. In a typical unitized frame assembly, sometimes referred to as a space frame assembly, the structural components of the body portion and the frame portion are combined into a single integral unit that is resiliently supported upon the vehicle wheels by the suspension system. Unitized frame assemblies of this general type are found in many relatively small modern vehicles, such as automobiles and minivans.

Most known vehicular frame assemblies are formed from a plurality of individual structural components that are permanently joined to one another. In the past, the various structural components have been secured directly to one another to form the vehicular frame assembly. Magnetic pulse forming and magnetic pulse welding are two well known processes that can be used to permanently join the individual structural components to one another. Typically, a magnetic pulse forming or welding process is performed by initially disposing portions of first and second workpieces in an overlapping relationship. Then, an electromagnetic field is generated either within or about the overlapping portions of the first and second workpieces. When this occurs, a large pressure is exerted on one of the first and second workpieces, causing it to move toward the other of the first and second workpieces.

If the electromagnetic field is generated about the exterior of the two workpieces, then the outer workpiece is deformed inwardly into engagement with the inner workpiece. If, on the other hand, the electromagnetic field is generated within the interior of the two workpieces, then the inner workpiece is deformed outwardly into engagement with the outer workpiece. In a magnetic pulse forming process, a relatively low intensity electromagnetic field is generated. As a result, the first workpiece impacts the second workpiece at a relatively small velocity, thereby causing the first workpiece merely to be deformed into conformance with the second workpiece. In a magnetic pulse welding process, a relatively high intensity electromagnetic field is generated. As a result, the first workpiece impacts the second workpiece at a relatively large velocity, thereby causing the first workpiece to be permanently secured to the second workpiece.

More recently, it has been proposed to manufacture a vehicular frame assembly by providing a plurality of structural components and a plurality of nodes. The ends of the structural components are secured to the nodes to form the vehicular frame assembly. Although this process has been found to be effective, it has been found to be relatively time consuming and expensive to manufacture the nodes. Also, it has been found to be relatively difficult to secure ends of the structural components to the nodes using the magnetic pulse forming and welding techniques described above. Thus, it would be desirable to provide an improved method of manufacturing a node and of securing a plurality of structural components to the node to form an article, such as a vehicle frame assembly.

### SUMMARY OF THE INVENTION

This invention relates to an improved method of manufacturing a node and of securing a plurality of structural components to the node to form an article, such as a vehicle frame assembly. The node is manufactured by initially extruding a workpiece having a plurality of longitudinally extending passageways formed therethrough. A plurality of interim workpieces can be formed by separating portions of the extruded workpiece into a plurality of discrete sections. If necessary, the interim workpieces can be machined to provide a plurality of nodes. The nodes can be formed or machined to have one or more bores formed therethrough that extend from a first outer surface to a second outer surface. A portion of the structural member is inserted into the bore from the first outer surface of the node, while a magnetic pulse forming/welding inductor is inserted into the bore from the second outer surface of the node. The magnetic pulse forming/welding inductor is then operated to secure the portion of the structural member to the node to form an assembly.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a workpiece that can be used to form a node in accordance with the method of this invention.

FIG. 2 is a perspective view of a plurality of interim workpieces that have been formed from the workpiece illustrated in FIG. 1.

FIG. 3 is an enlarged exploded perspective view of one of the interim workpieces illustrated in FIG. 2 after having portions thereof removed to form a node, together with a plurality of structural components to be secured thereto.

FIG. 4 is an exploded sectional elevational view of the node and some of the structural components illustrated in FIG. 3, together with a plurality of magnetic pulse forming/welding inductors for securing the structural components to the node.

FIG. 5 is a further enlarged sectional elevational view showing the assembly of the node, one of the structural components, and one of the magnetic pulse forming/welding inductors illustrated in FIG. 4.

FIG. 6 is a perspective view of a vehicle frame assembly that can be manufactured in accordance with the method of this invention.

### DETAILED DESCRIPTION OF THE PREFERRED EMBODIMENT

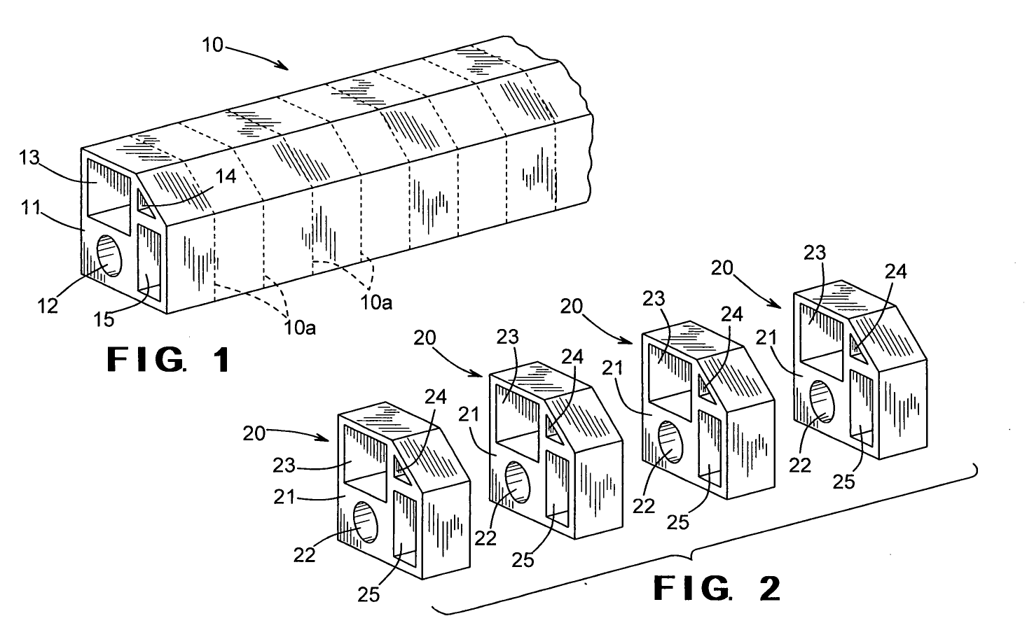

Referring now to the drawings, there is illustrated in FIG. 1 a workpiece, indicated generally at 10, that can be used to form a node or a plurality of nodes in accordance with the method of this invention. The illustrated workpiece 10 includes a body portion 11 that is longitudinally elongated and has a generally rectilinear cross sectional shape. However, the workpiece 10 can be formed having any desired shape. A first passageway 12 having a generally circular cross sectional shape is formed longitudinally through the body portion 11 of the illustrated workpiece 10. Second, third, and fourth passageways 13, 14, and 15, each having generally rectilinear cross sectional shapes, are also formed longitudinally through the body portion 11 of the illustrated workpiece 10. Although four passageways 12, 13, 14, and 15 are shown in the illustrated embodiment, it will be appreciated that any other number of such passageways 12, 13, 14, and 15 can be formed through the body portion 11 of the workpiece 10. Similarly, the cross sectional shapes of the various passageways 12, 13, 14, and 15 can be varied from those illustrated as desired. Furthermore, it will be appreciate that the workpiece 10 can be initially formed having none of such passageways 12, 13, 14, and 15 formed therethrough. The purpose for the illustrated passageways 12, 13, 14, and 15 will be explained below.

The illustrated workpiece 10 is preferably formed by a conventional extrusion process. The extrusion process is preferred because it is well suited to form the longitudinally extending passageways 12, 13, 14, and 15 as the body portion 11 of the illustrated workpiece 10 is being created. However, it will be appreciated that the workpiece 10 of this invention can be formed by any other desired manufacturing process, such as by casting, forging, and the like. Furthermore, the passageways 12, 13, 14, and 15 can be formed by any other desired manufacturing process as well, such as by drilling, cutting, machining, and the like. The workpiece 10 can be formed from any desired material or combination of materials. Preferably, however, the workpiece 10 is formed from a metallic material.

FIG. 2 is a perspective view showing a plurality of interim workpieces, each indicated generally at 20, that can be formed from the workpiece 10 illustrated in FIG. 1. The plurality of interim workpieces 20 can be formed by separating portions of the workpiece 10 illustrated in FIG. 1 into a plurality of discrete sections. For example, the plurality of interim workpieces 20 can be formed cutting the workpiece 10 along the length thereof, such as shown by the dotted lines 10a illustrated in FIG. 1. After such cutting, each of the interim workpieces 20 includes a first passageway 22, having a generally circular cross sectional shape, and second, third, and fourth passageways 23, 24, and 25, each having a generally rectilinear cross sectional shape.

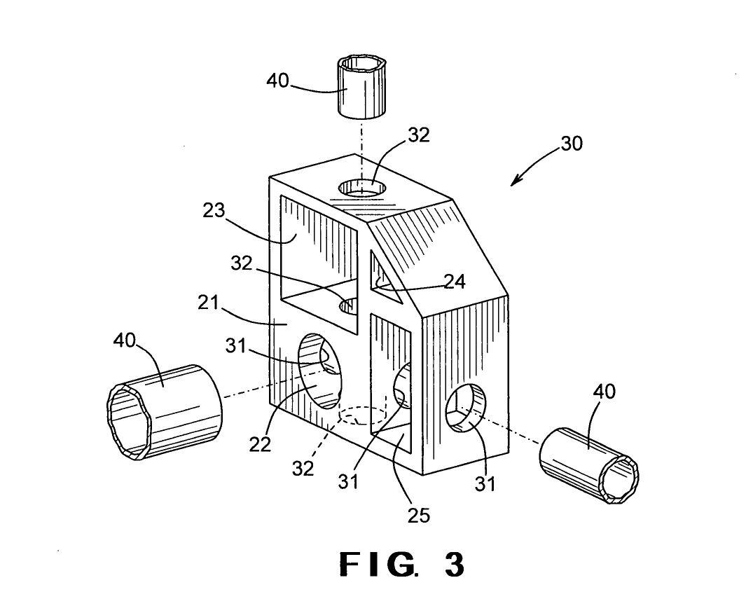

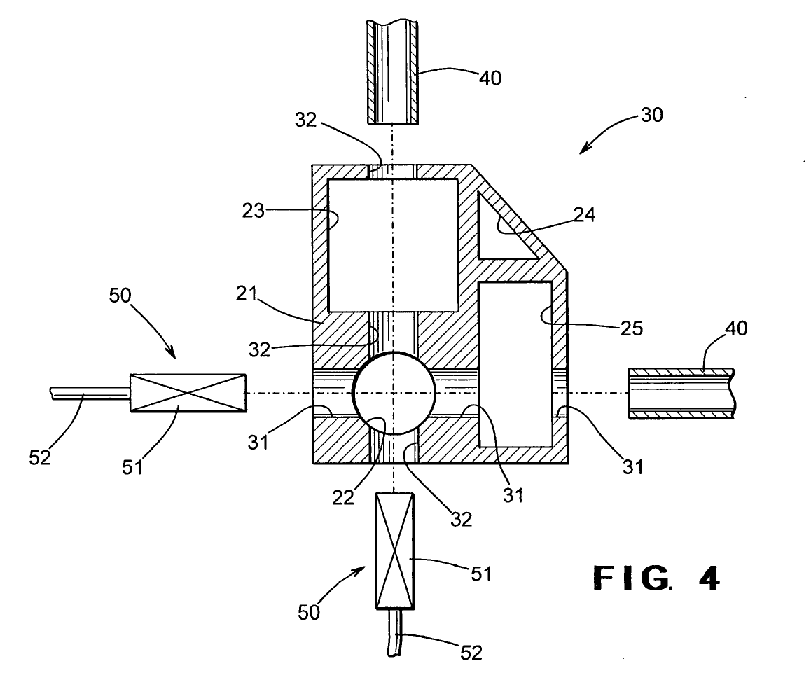

FIGS. 3 and 4 illustrate the structure of one of the interim workpieces 20 illustrated in FIG. 2 after having portions thereof removed to form a node, indicated generally at 30. As shown therein, a first through bore 31 is formed through the body portion 21 of the interim workpiece 20. In the illustrated embodiment, the first through bore 31 extends linearly through the body portion 21 of the interim workpiece 20 from a first outer surface to a second outer surface that is opposed to the first outer surface, although such is not necessary. Also, in the illustrated embodiment, the first through bore 31 intersects with both the first passageway 22 and the fourth passageway 25, although again such is not necessary. Similarly, a second through bore 32 is formed through the body portion 21 of the interim workpiece 20. In the illustrated embodiment, the second through bore 32 extends linearly through the body portion 21 of the interim workpiece 20 from a third outer surface to a fourth outer surface that is opposed to the third outer surface, although again such is not necessary. Also, in the illustrated embodiment, the second through bore 32 intersects with both the first passageway 22 and the second passageway 23, although such is not necessary. The illustrated first and second through bores 31 and 32 are generally cylindrical in shape. However, the first and second through bores 31 and 32 can be formed having any desired cross sectional shape or shapes.

As also shown in FIGS. 3 and 4, a plurality of structural components 40 can be connected to the node 30 for forming an article. In the illustrated embodiment, three of such structural components 40 are connected to the node 30. However, it will be appreciated that any number of such structural components 40 can be connected to the node 30. For reasons that will become apparent below, the ends of the structural components 40 that are connected to the node 30 are preferably formed having a cross sectional shape that is the same or similar to the cross sectional shape of the through bores 31 and 32 to which they are connected. Thus, in the illustrated embodiment, the ends of the structural components 40 are formed having a generally cylindrical shape. However, the ends of the structural components 40 may be formed having any desired cross sectional shape.

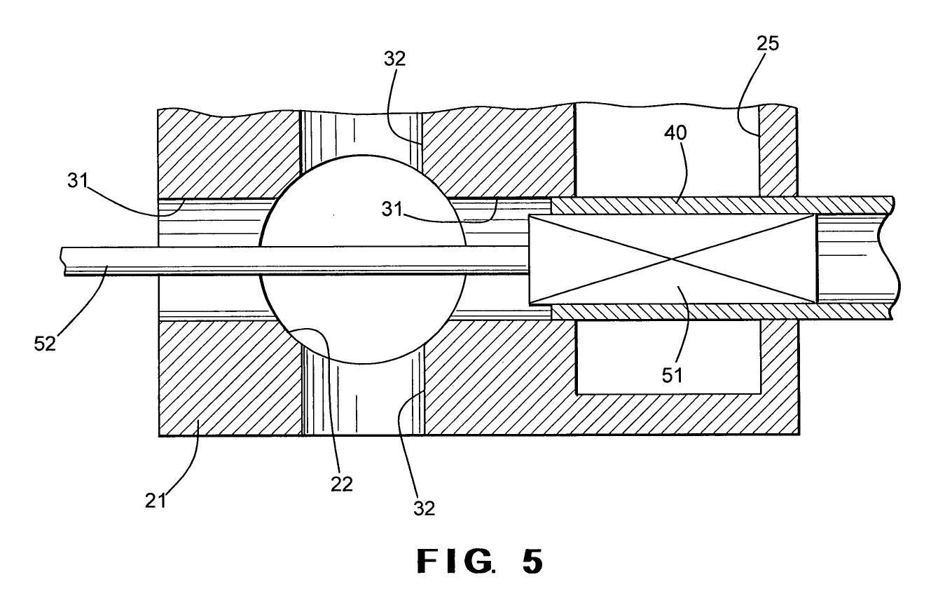

FIGS. 3, 4, and 5 illustrate how the ends of the structural components 40 can be secured to the node 30 in accordance with the method of this invention. As shown in FIGS. 3 and 4, the end of one of the structural components 40 is initially co-axially aligned with the first through bore 31 formed through the node 30. Then, the end of the structural component 40 is inserted co-axially within at least a portion of the first through bore 31, as shown in FIG. 5. Preferably, the end of the structural component 40 defines an outer dimension that is at least slight smaller than an inner dimension defined by the first through bore 31. Such relative sizing not only facilitates the insertion of the end of the structural component 40 within the first through bore 31, but also facilitates its securement thereto, as described below.

An internal magnetic pulse forming/welding inductor assembly, indicated generally at 50, is provided to connect the end of the structural component 40 to the node 30. The inductor assembly 50 is generally conventional in the art and includes an electromagnetic coil 51 that is carried on a movable support 52. The coil 51 is composed of a winding of an electrical conductor having leads (not shown) that extend therefrom through a switch (not shown) to a source of electrical power (not shown). In a manner that is known in the art, when the switch is closed, a closed electrical circuit is formed through the leads between the source of electrical power and the coil 51. As a result, electrical current flows through the coil 51, causing a magnetic field of relatively large intensity to be generated within the end of the structural component 40. This relatively large intensity magnetic field exerts a large pressure on the end of the structural component 40, causing it to expand outwardly toward the interior portions of the node 30.

The inductor assembly 50 can be used to secure the end of the structural component 40 to the node 30 by means of a magnetic pulse forming process. In a magnetic pulse forming process, a relatively low intensity electromagnetic field is generated by the inductor assembly 50. As a result, the end of the structural component 40 is expanded outwardly into engagement with the node 30 at a relatively small velocity. In some instances, the mechanical engagement between the end of the structural component 40 and the node 30 may provide a sufficient connection therebetween. In other instances, it may be desirable to provide a supplemental securement operation to secure the end of the structural component 40 to the node 30. For example, it may be desirable to initially provide an adhesive material (not shown) between the end of the structural component 40 to the node 30, then use the magnetic pulse forming process to move the end of the structural component 40 into engagement with the node 30. Alternatively, it may be desirable to initially use the magnetic pulse forming process to move the end of the structural component 40 into engagement with the node 30, then permanently secure the two together using conventional welding techniques. This invention contemplates that any other desired supplemental securement operation can be used before, during, or after the performance of the magnetic pulse forming process.

The inductor assembly 50 can alternatively be used to secure the end of the structural component 40 to the node 30 by means of a magnetic pulse welding process. In a magnetic pulse welding process, a relatively high intensity electromagnetic field is generated by the inductor assembly 50. As a result, the end of the structural component 40 is expanded outwardly into engagement with the node 30 at a relatively large velocity. The high velocity impact of these two components, as well as the large pressures exerted thereon, causes the two components to become permanently joined together, as shown in FIG. 5.

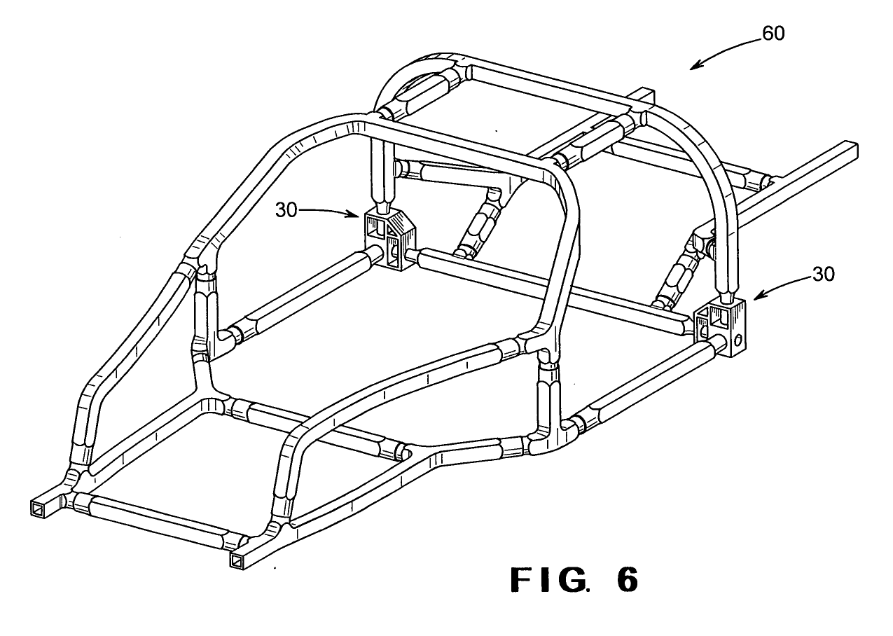

Referring now to FIG. 6, there is illustrated a vehicular frame assembly, indicated generally at 60, that can be manufactured in accordance with the method of this invention. The illustrated vehicular frame assembly 60 is, in large measure, conventional in the art and is intended merely to illustrate one environment in which this invention may be used. Thus, the scope of this invention is not intended to be limited for use with the specific structure for the vehicular frame assembly 60 illustrated in FIG. 6 or with vehicular frame assemblies in general. On the contrary, this invention may be used in any desired environment.

The illustrated vehicular frame assembly 60 is a unitized space frame assembly that includes a variety of different types of structural members that are secured to one another. A first type of structural member is a straight member, which is generally linear and elongated in shape. A second type of structural member is a curved member, which is non-linear and elongated in shape. A third type of structural member is a joint node, which is a relatively short member that is provided to join adjacent structural members of the vehicle frame assembly 60 together at a joint. A fourth type of structural member is a member node, which is a relatively long structural members that is also provided to join adjacent members of the vehicle frame assembly 60 at a joint. As shown in FIG. 6, a pair of the nodes 30 manufactured in accordance with the method of this invention can be used to secure a plurality of the various structural components together to form the unitized space frame assembly.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of manufacturing an assembly of structural components comprising the steps of:
(a) providing a workpiece;
(b) separating portions of the workpiece into a plurality of nodes;
(c) providing a plurality of structural members; and
(d) securing the structural members to each of the plurality of nodes to form an assembly of structural components.

2. The method defined in claim 1 wherein said step (a) is performed by forming the workpiece by extrusion.

3. The method defined in claim 1 wherein said step (a) is performed by providing the workpiece with a plurality of openings, and wherein said step (d) is performed by inserting portions of the structural members into the openings.

4. The method defined in claim 3 wherein said step (a) is performed by forming the openings in the nodes after step (b) has been performed.

5. The method defined in claim 1 wherein said step (d) is performed by a magnetic pulse forming process.

6. The method defined in claim 1 wherein said step (d) is performed by a magnetic pulse welding process.

7. A method of manufacturing an assembly comprising the steps of:
(a) providing a node including a body portion having a bore that extends through the body portion from a first outer surface to a second outer surface;
(b) providing a structural member;
(c) inserting a portion of the structural member into the bore from the first outer surface of the node;
(d) inserting a magnetic pulse forming/welding inductor into the bore from the second outer surface of the node; and
(e) operating the magnetic pulse forming/welding inductor to secure the portion of the structural member to the node to form an assembly.

8. A method of manufacturing an assembly comprising the steps of:
(a) providing a node including a body portion having a plurality of bores that each extend through the body portion from a first outer surface to a second outer surface;
(b) providing a plurality of structural members;
(c) inserting a portion of each of the structural members into a respective one of the bores from the first outer surfaces of the node;
(d) inserting a magnetic pulse forming/welding inductor into each of the bores from the second outer surfaces of the node; and
(e) operating the magnetic pulse forming/welding inductor to secure the portions of the structural members to the node to form an assembly.
